(19) United States
(12) Patent Application Publication
(10) Pub. No.: US 2009/0179836 A1
(43) Pub. Date: Jul. 16, 2009

(54) GAMMA CORRECTION METHOD, GAMMA CORRECTION APPARATUS, AND DISPLAY DEVICE

(75) Inventor: JIAN-SHENG ZHOU, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 11/972,506

(22) Filed: Jan. 10, 2008

(51) Int. Cl. G09G 3/34

(52) U.S. Cl. 345/84

(57) ABSTRACT

An exemplary gamma correction method for use in a display device is disclosed. The display device includes a lamp, and a memory. The lamp is configured to generate light which is modulated into a visual image. The memory is configured for storing a plurality of gamma correction settings. The gamma correction method comprising: measuring service time of the lamp; receiving input displayable signals; and correcting the input displayable signals using a corresponding gamma correction setting, based on the measured service time of the lamp.

### BACKGROUND

1. Technical Field

The invention relates to gamma correction methods/apparatuses and, particularly, relates to a gamma correction method and apparatus for use in a display device, and the display device.

2. Description of Related Art

Most display devices such as digital light processing (DLP) projectors have a nonlinear input-output (e.g., voltage-brightness) characteristic in brightness and color, and therefore employ a gamma correction function (correcting the input using gamma correction curves/tables (voltage-voltage)) to compensate for the display devices. These display devices commonly employ a lamp as light source configured to generate light that will be modulated into a visual image. One challenge of utilizing gamma correction is: as the lamp ages, output (brightness) of the lamp decays/decreases, a gamma curve given by the manufacturer based on the output of a brand-new lamp may become unsuitable.

Therefore, it is desirable to provide a gamma correction method and apparatus, and a display device, which can overcome the abovementioned problem.

### SUMMARY

In a present embodiment, a gamma correction method for use in a display device is disclosed. The display device includes a lamp, and a memory. The lamp is configured to generate light which is modulated into a visual image. The memory is configured for storing a plurality of gamma correction settings (in a form of input-output curves/tables). The gamma correction method comprising: measuring service time of the lamp; receiving input displayable signals; and correcting the input displayable signals using a corresponding gamma correction setting, based on the measured service time of the lamp.

### BRIEF DESCRIPTION OF THE DRAWINGS

Many aspects of the present gamma correction apparatus, gamma correction method, and display device should be better understood with reference to the following drawings. The components in the drawings are not necessarily drawn to scale, the emphasis instead being placed upon clearly illustrating the principles of the present gamma correction apparatus, gamma correction method, and display device. Moreover, in the drawings, like reference numerals designate corresponding parts throughout the several views.

FIG. 1 is a functional view of a display device, according to an embodiment.

FIG. 2 is a flow chart of a gamma correction method, according to another embodiment.

### DETAILED DESCRIPTION OF THE EMBODIMENTS

Embodiments of the present gamma correction apparatus, gamma correction method, and display device will now be described in detail with reference to the drawings.

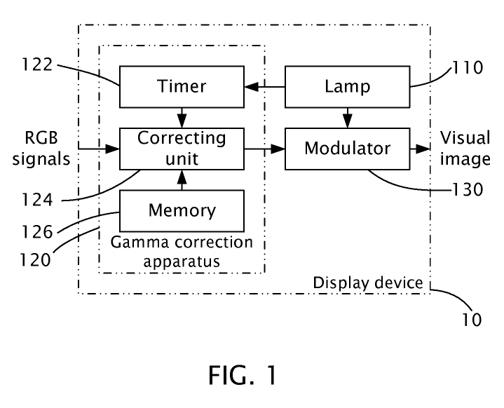

Referring to FIG. 1, a display device 10 in accordance with an embodiment includes a lamp 110 (e.g., xenon lamp, a mercury lamp, or a light emitting diode module), a gamma correction apparatus 120, and a modulator 130. The gamma correction apparatus 120 includes a timer 122, a memory 124, and a correcting unit 126. The timer 122 is configured for timing service time of the lamp 110. The memory 124 is configured for storing a number of gamma correction settings (e.g., each gamma correction setting is a group of gamma correction curves mapped by the manufacturer in different phases of the lamp 110), corresponding to different phases of the service time of the lamp. The correcting unit 126 is configured to receive input displayable signals (e.g., RGB signals) and correct the input displayable signals using a corresponding gamma correction setting, based on the phases of the service time of the lamp 110. The modulator 130 is configured to modulate light generated from the lamp 110 into a visual image based on the corrected input displayable signals.

The display device 10 should be read broadly to encompass any device that produces visual images by modulating light from a lamp, such as DLP projector, or liquid crystal on silicon (LCOS) projector. In this embodiment, the display device 10 is a DLP projector. In addition to the lamp 110 and the modulator 130 (i.e., digital micro-mirror device), the DLP projector may further include a color wheel configured for dispersing light from the lamp 110 into, for example, red (R), green (G), and blue (B) lights in sequence, which will be sequently modulated by the modulator 130 to produce color components (e.g., R, G, and B color components) of a visual image. In practice, each color component typically has a unique nonlinear input-output characteristic. Accordingly, each gamma correction setting of this embodiment includes three gamma correction curves: for example, R, G, and B gamma correction curves, each configured to correct the input displayable signals in a respective color component. Understandably, if the display device 10 is a black-white type, each gamma setting is a gamma correction curve configured to correct brightness of the input displayable signals.

Opportunely, lamp 110 is replaceable and the timer 122 can be reset accordingly.

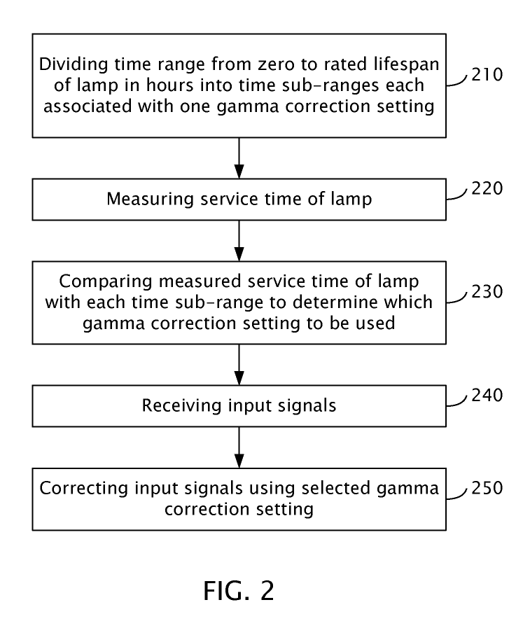

Referring to FIG. 2, a gamma correction method for use in the display device 10, according to an exemplary embodiment, includes the following operations 210˜250.

Operation 210: dividing a time range: 0˜T into a number of time sub-ranges (a phase of the service time of the lamp 110), each of which is associated with a respective gamma correction setting (three gamma correction curves: R, G, and B), where T is the rated lifespan of the lamp 110 in hours (lamp life). In detail, this can be done by the manufacturer, and the time sub-ranges are stored in the correcting unit 126. Alternatively, these time sub-ranges can be written into the correcting unit 126 by the user. In this embodiment, it is assumed that the rated lifespan of the lamp 110 in hours is 2700 h, and the time range 0˜2700 h is divided into four time sub-ranges: 0˜400 h, 400 h˜1100 h, 1100h˜1700 h, and 1700 h˜2700 h by the manufacturer. Accordingly, the memory 124 stores four gamma correction settings.

Operation 220: measuring service time the lamp 110. In detail, this can be carried out by the timer 122.

Operation 230: comparing the measured service time of the lamp 110 with each time sub-range to determine which time sub-range/phase the measured service time the lamp 110 belongs to, and thereby selecting the corresponding gamma correction setting to be used. In detail, this can be carried out by the correcting unit 126.

Operation 240: receiving input displayable signals. In particular, this is done by the correcting unit 126.

Operation 250: correcting the input displayable signals using a corresponding gamma correction setting (the gamma correction setting selected in the operation 230).

Specifically, the gamma correction method may also include an operation 200 if the gamma correction method starts with a brand-new lamp.

Operation 200: resetting the timer 122. This can be done by the user.

Clearly, the gamma correction apparatus 120 and the gamma correction method are advantageous because they can rewrite/reselect a more suitable gamma setting so as to fittingly correct the input displayable signals during different periods of the lamp life.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A gamma correction apparatus for use in a display device, the display device comprising a lamp configured to generate light which is modulated into a visual image, the gamma correction apparatus comprising:
a timer configured for timing service time of the lamp;
a memory configured for storing a plurality of predetermined gamma correction settings, corresponding to different phases of the service time of the lamp; and
a correcting unit configured for receiving input displayable signals and correcting the input displayable signals using a corresponding gamma correction setting, based on the phase of the service time of the lamp.

2. The gamma correction apparatus as claimed in claim 1, wherein the timer is resettable.

3. The gamma correction apparatus as claimed in claim 1, wherein each of the gamma correction settings comprises a gamma correction curve configured to correct brightness of the input displayable signals.

4. The gamma correction apparatus as claimed in claim 1, wherein each of the gamma correction settings comprises a red, green, and blue gamma correction curve configured to respectively correct red, green, and blue components of the input displayable signals.

5. A gamma correcting method for use in a display device, the display device comprising a lamp configured to generate light which is modulated into a visual image, and a memory configured for storing a plurality of gamma correction settings, the gamma correction method comprising:
measuring service time of the lamp;
receiving input displayable signals; and
correcting the input displayable signals using a corresponding gamma correction setting, based on the measured service time of lamp.

6. The gamma correction method as claimed in claim 5, wherein each of the gamma correction settings is predetermined according to different phases of the service time of the lamp.

7. A display device comprising:
a lamp configured for generating light;
a gamma correction apparatus comprising:
a timer configured for timing service time of the lamp;
a memory configured for storing a plurality of predetermined gamma correction settings, corresponding to different phases of the service time of the lamp; and
a correcting unit configured for receiving input displayable signals and correcting the input displayable signals using a corresponding gamma correction setting, based on the phase of the service time of the lamp; and
a modulator configured for modulating the light from the lamp into a visual image according to the corrected input displayable signals.

8. The display device as claimed in claim 7, being selected from a group consisting of digital light processing projector, and liquid crystal on silicon projector.

9. The display device as claimed in claim 7, wherein the lamp is selected from a group consisting of: xenon lamp, mercury lamp, and light emitting diode module.

10. The display device as claimed in claim 7, wherein the lamp is replaceable.

11. The display device as claimed in claim 7, wherein the timer is resettable.

12. The display device as claimed in claim 7, wherein each of the gamma settings includes a gamma curve configured to correct brightness of the input displayable signals.

13. The display device as claimed in claim 7, wherein each of the gamma settings comprises a plurality of gamma curves each configured to correct color components of the input displayable signals.
